(19) United States
(12) Patent Application Publication
(10) Pub. No.: US 2008/0100237 A1
(43) Pub. Date: May 1, 2008

(54) Dual fan module system with three power options using two single throw relays and one double throw relay and a series resistor

(75) Inventors: Attila Simofi-Ilyes, London (CA); Andrew Lakerdas, London (CA); Mike Toner, Appin (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Canada Inc., Chatham (CA)

(21) Appl. No.: 11/979,299

(22) Filed: Nov. 1, 2007

Related U.S. Application Data
(60) Provisional application No. 60/863,870, filed on Nov. 1, 2006.

(51) Int. Cl. H02P 5/68

(52) U.S. Cl. 318/82; 318/112

(57) ABSTRACT

A multi-powered electric motor system (21) is provided for a vehicle. The system includes first and second direct current motors (12, 14), each constructed and arranged to operate at a single speed. Current limiting structure (R1) is constructed and arranged to lower electrical input power to the motors so that a speed of the motors is reduced when the motors are powered together with the current limiting structure, as compared to a speed of the motors powered absent the current limiting structure. Switching structure (K1, K2, K3) is selectively operable to cause the motors to operate at various speeds resulting in three discrete power levels of the system.

This application claims the priority benefit of Provisional Application No. 60/863,870 filed on Nov. 1, 2006, the content of which is hereby incorporated by reference into this specification.

### FIELD OF THE INVENTION

This invention relates to motors for automotive applications such as, but is not limited to: engine cooling, where a duel electric motor and a fan module assembly is operated at more than two speeds; and HVAC (Heating, Ventilation and Air Conditioning).

### BACKGROUND OF THE INVENTION

A series-parallel switching method (with two single throw and one double throw relay system) is one of the most economical and commonly used to achieve two speed operations of a dual module in an engine cooling application. As shown in FIG. 1, a typical dual module 10 contains two single speed electric motors 12, 14 with fans 16, 18 mounted on a shroud structure 20. The electrical schematic of this series-parallel configuration is shown in FIG. 2. The sequence for energizing the relays K1, K2, and K3 to achieve the two speed operation and one OFF state is shown in FIG. 3.

One of the shortcomings of the series-parallel system is the Low Speed (low power level) operation. When the two motors are connected in series, the power of each motor is reduced significantly (total power of both motors at Low Speed is approx. 20% of High Speed) compared to High Speed (high power level) operation (when the motors are connected in parallel). The Low Speed operation of the dual module is configured for cooling the radiator during vehicle idling and quiet/low noise operation is required. However, in many cases (depending on the system configuration and the vehicle application) the Low Speed operation does not provide sufficient cooling/airflow through the radiator. Therefore, the Electronic Control Unit (ECU) switches the module into High Speed. The High Speed operation typically produces a high noise level since both fans are rotating at high speed. The high speed (high power level) is configured for ram air condition when the vehicle is in motion approx. 50 to 90 km/hr. Under normal circumstances when the vehicle is in motion at high speed, the noise from the rotating tires overcomes all other noise in the vehicle.

In order to reduce noise, OEM's are requesting a Medium Speed (medium power level) operation of the dual fan engine cooling module that meets both the airflow and overall noise requirements. There are several methods available on the market to achieve multi-speed operations (multi power stages) with additional external devices/components. However, these methods employ relatively complex and costly systems.

Therefore, there is a need to provide a new, low cost solution to achieve three speed operation of an electric motor used in automotive applications such as an engine cooling module.

### SUMMARY OF THE INVENTION

An object of the invention is to fulfill the need referred to above. In accordance with the principles of the present invention, this objective is achieved by providing a multi-powered electric motor system for a vehicle. The system includes first and second direct current motors, each constructed and arranged to operate at a single speed. Current limiting structure is constructed and arranged to lower electrical input power to the motors so that a speed of the motors is reduced when the motors are powered together with the current limiting structure, as compared to a speed of the motors powered absent the current limiting structure. Switching structure is selectively operable to cause the motors to operate at various speeds resulting in three discrete power levels of the system.

In accordance with another aspect of the invention, a method is provided for operating a system having first and second single speed direct current motors, with the motors operating at various speeds resulting in a first low power level, a second medium power level and a third high power level of the system. The method arranges the first and second motors in a parallel circuit. The single resistor is connected in series with both the first and second motors during the first low power level. The resistor is connected in series with only one of the motors with the other motor operated at full speed during the second medium power level. Both the first and second motors bypass the resistor and are operated at full speed during the third high power level.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of a conventional dual module with two single speed electric motors and associated fans.

FIG. 2 is a schematic of series-parallel configuration of the module of FIG. 1.

FIG. 3 shows the sequence for energizing the relays of FIG. 2.

FIG. 4 is schematic of a three power stage, dual module system provided in accordance with the principles of an embodiment of the invention.

FIG. 5 shows the sequence for energizing the relays of FIG. 4.

FIG. 6 shows speed/torque separation between the two motors of FIG. 4.

FIG. 7 is a view of the dual fan module of FIG. 4 showing the electrical connector incorporating the series resistor.

FIG. 8 is a view of the module of FIG. 4 showing the series resistor as a separate, plug-in device.

FIG. 9 is graph comparing the airflow performance (Static pressure vs. Air flow rate) of a conventional dual module system with two speed (two power stage with series-parallel configuration) and the three power stage system of FIG. 4.

### DETAILED DESCRIPTION OF THE EXEMPLARY EMBODIMENTS

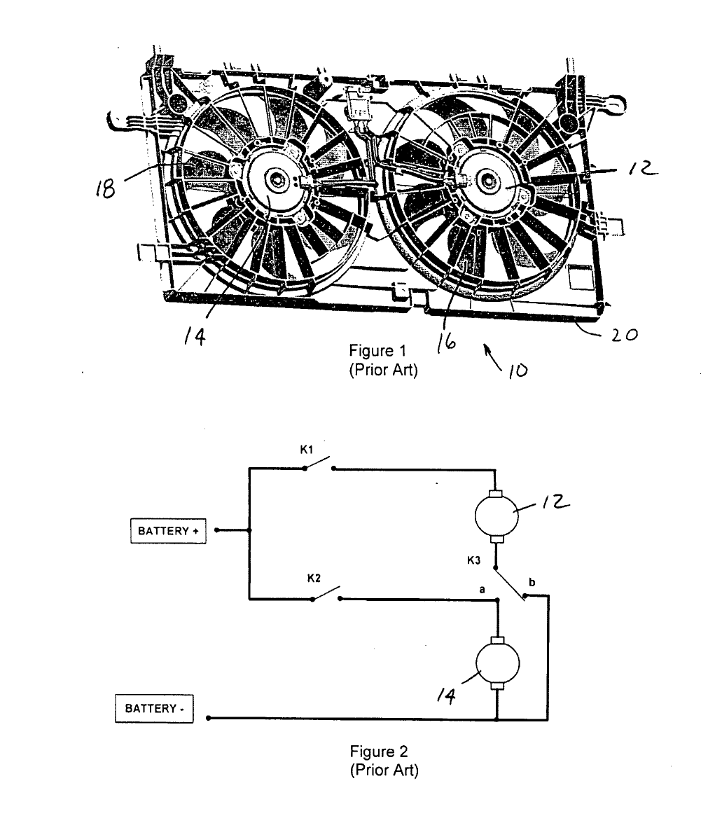

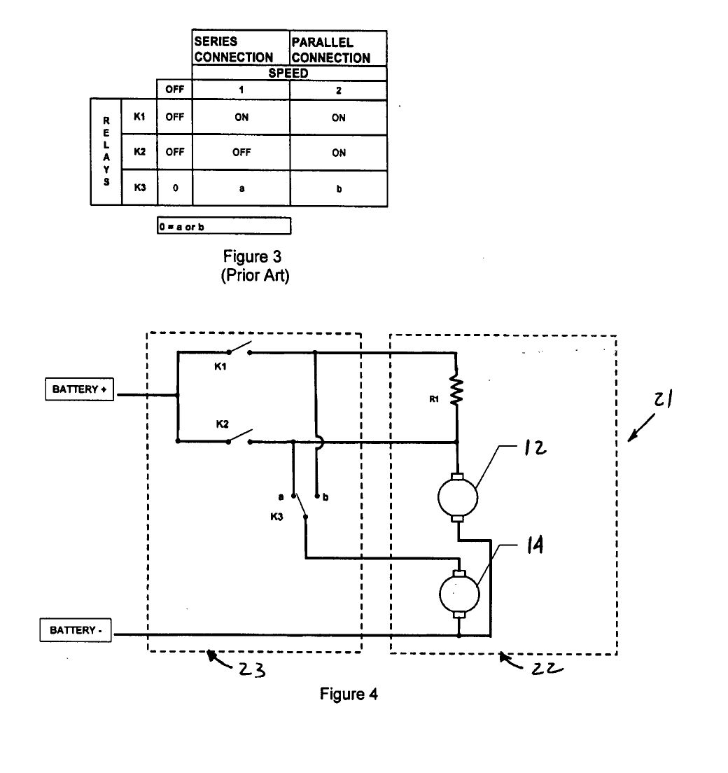

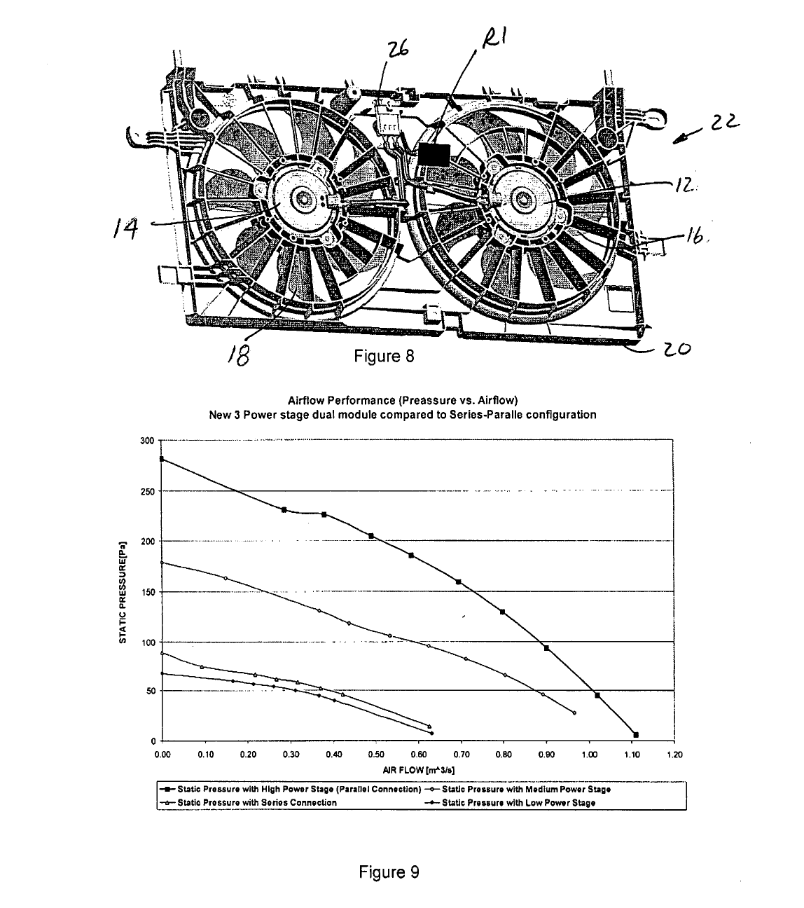

A dual module, three stage power system, provided in accordance with the principles of the invention is shown, generally indicated at 21, in FIG. 4. The system 21 includes a dual fan module, generally indicated at 22, and an electrical circuit, generally indicated at 23, associated with a vehicle. With reference to FIG. 7, the dual fan module 22 includes a first motor 12 for operating a first fan 16 and a second motor 14 for operating a second fan 18. The motors and fans are associated with the conventional shroud 20. The motors are conventional and are preferably single, speed permanent magnet DC motors as in FIG. 1. In the illustrated embodiment of FIG. 4, the system 21 includes three power switches K1, K2 and K3, associated with the two motors 12, 14, and series resistor R1. In the embodiment, the power switches K1, K2 and K3 are preferably electromagnetic relays, with K1 and K2 being single throw relays and K3 being a double throw relay. As shown in FIG. 4, the resistor R1 is part of the dual fan module 22, but it can be part of the vehicle electrical circuit 23. As shown in FIG. 7, the series resistor R1 is preferably part of the electrical connector 26 (four pin connector) for electrical connection to the electrical circuit 23. Alternatively, the resistor R1 can be separate from but electrically associated with the connector 26 or the lead wiring harness, or can be a separate plug-in device, as shown in FIG. 8, associated with the wiring that powers the motors.

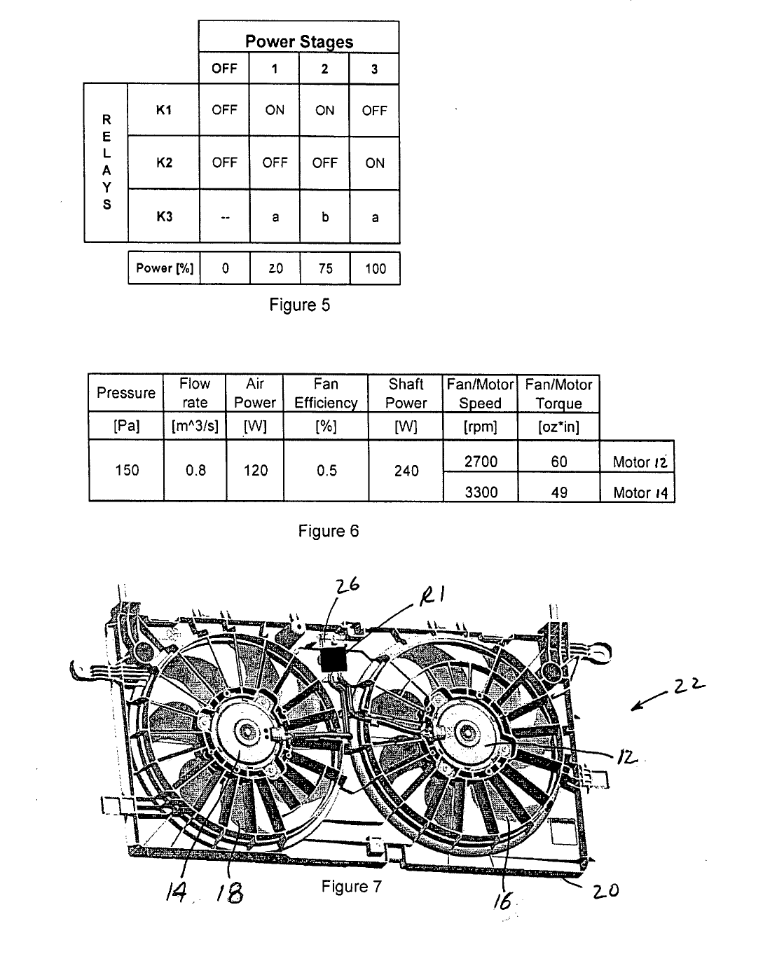

FIG. 5 shows the tabulated operational sequence of the three relays K1, K2 and K3 to achieve various speeds for the motors resulting in three discrete power levels of the system 21, and an OFF state for the system 21. At Power Stage 1 (low power level) the resistor R1 is connected/switched in series with both motors 12, 14 (the motors 12, 14 are in a parallel circuit). At Power Stage 2 (medium power level), the motor 14 is running at full speed (high power level) and the motor 12 is running at low speed (low power level) through the series resistor R1. At Power Stage 3 (high power level), both motors 12, 14 are bypassing the series resistor R1 and running at full speed (high power level) with the two motors being in a parallel circuit.

Although during Power Stage 2 (medium power level) the motor 14 and fan 18 rotate at full speed (high power stage), the overall noise level is still lower than the noise level of the dual module system 21 at Power Stage 3 (high power level). To optimize the overall noise level of the dual module system 21 at medium power stage the fan diameter and operating speed of the fan 16 and fan 18 needs to be calculated. As an example to achieve the same noise at fans 16 and 18, the diameter and speed of the fans are defined by the following equation: (D16/D18)=(N18/N16)^{̂(5/7)}, where the D16 is the diameter of the fan 16 and D18 is the diameter of the fan 18 and N18 is the rotational speed of the fan 18 and N16 is the rotational speed of the fan 16 (also assuming same fan design in both fans and same air density). Typically, for more optimum heat rejection, it is desirable to have equal air power across a radiator surface. This can be maintained with the system 21 since the air power linearly proportional to pressure and the flow rate produced by the rotating fans and also it is the product of motor shaft power and fan efficiency. Therefore the motor 12 and fan 16 are configured to operate at a lower speed than the motor 14 and fan 18, when both are energized at full speed. However, to maintain substantially the same shaft power at both motors 12, 14, the operating torque is higher for motor 12 and fan 16 than the motor 14 and fan 18. The shaft power is the directly proportional to the product of Torque and Speed.

Thus, the two motors 12 and 14 are connected in a parallel circuit during each power stage. The resistor R1 is connected in series to both motors 12, 14 during the low Power Stage 1. The resistor R1 is connected in series with one motor only during medium Power Stage 2.

An example calculation is shown in FIG. 6 for the speed/torque separation between the motor 12 and motor 14.

FIG. 9 is a graph comparing the airflow performance (Static pressure vs. Air flow rate) of the conventional dual module system with two speed (two power stage with series-parallel configuration of FIG. 1) and the three power stage system 21 of the embodiment. The low Power Stage 1 of the system 21 is the same/similar to the low power stage of the series-parallel system of FIG. 1. However, the medium Power Stage 2 of the dual fan module 22 is approximately 70 to 80% of full power stage and the overall noise level at medium Power Stage 2 is 4 to 6 dBA lower than the high Power Stage 3. The reduction of operating speed of the motor 14 and fan 18 during the medium Power Stage 2 depends on the resistance of the series resistor R1.

The system 21 takes advantage of the existing components in the series-parallel configuration of FIG. 1. With a novel arrangement of the relays and with a series resistor an additional speed, (a medium Power Stage 2) can be achieved. This is an innovative and economical solution to obtain an additional, medium power stage for the vehicles already using the three relay system for series-parallel fan module operation with two single speed motors.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A multi-powered electric motor system for a vehicle comprising:
first and second direct current motors, each constructed and arranged to operate at a single speed,
current limiting structure constructed and arranged to lower electrical input power to the motors so that a speed of the motors is reduced when the motors are powered together with the current limiting structure, as compared to a speed of the motors powered absent the current limiting structure, and
switching structure selectively operable to cause the motors to operate at various speeds resulting in three discrete power levels of the system.

2. The system of claim 1, wherein the first and second motors are each permanent magnet motors.

3. The system of claim 1, wherein the current limiting structure is a single resistor and the switching structure includes first and second single throw relays and one double throw relay, the three different power levels being a first, low power level, a second, medium power level and a third, high power level, the motors being in a parallel circuit.

4. The system of claim 3, wherein at the first, low power level, the resistor is in series with both the first and second motors, with the first single throw relay being on and the second single throw relay being off and with the double throw relay being in a first position.

5. The system of claim 4, wherein at the second, medium power level, the relays and the resistor are constructed and arranged to ensure that the second motor operates at full power and the first motor operates at the first, low power level through the resistor, with the first single throw relay being on and the second single throw relay being off and with the double throw relay being in a second position.

6. The system of claim 5, wherein at the third, high power level, the relays and the resistor are constructed and arranged to ensure that both the first and second motors bypass the resistor and operate at full power, with the first single throw relay being off and the second single throw relay being on and with the double throw relay being in a first position.

7. The system of claim 1, wherein the system includes a dual fan module and a vehicle electrical system, the motors being part of the dual fan module with each motor being associated with a fan, and wherein the switching structure is part of the vehicle electrical system.

8. The system of claim 7, wherein the current limiting structure is a resistor that is part of the dual fan module.

9. The system of claim 8, wherein the resistor is integral with an electrical connector for powering the dual fan module.

10. The system of claim 8, wherein the resistor is a separate plug-in device associated with wiring that powers the motors.

11. The system of claim 1, wherein the switching structure is constructed and arranged to permit 1) the current limiting structure to be connected in series with both the first and second motors during a first, low power level, 2) the current limiting structure to be connected in series with only one of the motors, with the other motor being constructed and arranged to operate at full speed during a second, medium power level, and 3) both of the first and second motors to bypass the current limiting structure to operate at full speed during a third, high power level.

12. A method of operating a system having first and second single speed direct current motors, with the motors operating at various speeds resulting in a first low power level, a second medium power level and a third high power level of the system, the method including:
arranging the first and second motors in a parallel circuit,
ensuring that a single resistor is connected in series with both the first and second motors during the first low power level,
ensuring that the resistor is connected in series with only one of the motors with the other motor operated at full speed during the second medium power level, and
ensuring that both the first and second motors bypass the resistor and are operated at full speed during the third high power level.

13. The method of claim 12, wherein the motors are each permanent magnet motors.

14. The method of claim 12, wherein a double throw relay and first and second single throw relays are provided, the ensuring steps include operating the relays to obtain the first, second and third power levels.

15. The method of claim 14, wherein at the first, low power level, the method includes turning the first single throw relay on and turning the second single throw relay off and ensuring that the double throw relay is in a first position.

16. The method of claim 15, wherein at the second, medium power level, the method includes turning the first single throw relay on and turning the second single throw relay off and ensuring that the double throw relay is in a second position.

17. The method of claim 16, wherein at the third, high power level, method includes turning the first single throw relay off and turning the second single throw relay on and ensuring that the double throw relay is in the first position.

18. The method of claim 12, wherein the motors are part of a dual fan module of a vehicle, each fan being constructed and arranged to operate an associated fan, the method further including associating the resistor with an electrical connector of the dual fan module.
